(19) United States
(12) Patent Application Publication
(10) Pub. No.: US 2005/0178996 A1
(43) Pub. Date: Aug. 18, 2005

(54) Solvent-based fluorinated water and oil repellent and process for producing the same

(75) Inventors: Pei-Yuan Huang, Taipei City (TW); Ren-Ren Chiou, Taipei City (TW)

Correspondence Address: BACON & THOMAS, PLLC, 625 SLATERS LANE, FOURTH FLOOR, ALEXANDRIA, VA, 22314, US

(73) Assignee: JINTEX CORPORATION LTD., Taipei City (TW)

(21) Appl. No.: 10/816,814

(22) Filed: Apr. 5, 2004

(30) Foreign Application Priority Data
Feb. 12, 2004 (TW) 93103308

(51) Int. Cl. D06M 10/00; C08K 5/42

(52) U.S. Cl. 252/8.62; 524/589

(57) ABSTRACT

This invention discloses a solvent-based fluorinated water and oil repellent and process for producing the same. Said fluorinated water and oil repellent comprises 20˜50% (w/w) blocked polyfluorourethane compound and 50˜80% (w/w) solvent; its reaction agents include fluoroalcohol compound, diisocyanate or polymeric isocyanate compound, cross-linking agent, blocking agent, and solvent. The process for synthesizing the blocked polyfluorourethane is by bulk polymerization.

### BACKGROUND OF THE INVENTION

1. Field of the Invention

The present invention relates to a solvent-based fluorinated water and oil repellent and process for producing the same.

2. Description of the Related Art

Practically all fluorinated water and oil repellents exist in the form of solvent or aqueous dispersant, wherein solvent-type fluorinated water and oil repellents tend to pollute the environment and pose a fire hazard. Thus they are gradually replaced by aqueous dispersant-type fluorinated water and oil repellent systems in recent years. The production of water dispersant type fluorinated water and oil repellent requires the addition of surfactant and proper auxiliary surfactants in order for stabilize the fluoropolymers dispersed in the water. But due to technological limitation, all emulsion particles of fluorinated water and oil repellent products currently available tend to be unstable, change over time, and have limited applications. Oftentimes, fluorinated water and oil repellents have to be custom-made for textile or leather products. More so, aqueous dispersant type repellents lack washing durability and exhibit poor physical properties, which is one of the reasons why could not be applied extensively.

### SUMMARY OF THE INVENTION

To address the drawbacks of known water and oil repellents, the present invention provides a solvent-based fluorinated water and oil repellent comprising 20˜50% (w/w) blocked polyfluorourethane compound and 50˜80% (w/w) solvent.

According to the invention, the reaction agents for synthesizing said blocked polyfluorourethane compound comprise fluoroalcohol compound, diisocyanate or polymeric diisocyanate compound, cross-linking agent, blocking agent and solvent.

Another objective of the present invention is to provide a process for producing solvent-based fluorinated water and oil repellent, comprising the steps of: (a) reacting diisocyanate or polymeric diisocyanate compound with cross-linking agent to form a prepolymer having 1-3 mol equivalent percentage of terminal —NCO groups; (b) reacting said prepolymer with fluoroalcohol to form polyfluorourethane polymer having 0.5˜1.5 mol equivalent percentage of unreacted terminal —NCO groups; and (c) blocking said —NCO groups with blocking agent to obtain blocked polyfluorourethane.

Yet another objective of the present invention is to provide a process for producing solvent-based fluorinated water and oil repellent, comprising the steps of: (a) reacting 0.4˜0.6 mol equivalent percentage of cross-linking agent with 0.8˜1.2 mol equivalent percentage of diisocyanate or polymeric diisocyanate compound to form a prepolymer having 1-3 mol equivalent percentage of terminal —NCO groups; (b) reacting said prepolymer with 0.3˜0.6 mol equivalent percentage of fluoroalcohol to form polyfluorourethane having 0.5˜1.5 mol equivalent percentage of unreacted terminal —NCO groups; and (c) blocking said —NCO groups with 0.05˜0.4 mol equivalent percentage of blocking agent to obtain blocked polyfluorourethane.

If necessary, 50˜80 wt % of solvent can be added in various steps of the aforesaid process to reduce the viscosity of polymer in the reaction process.

In a preferred embodiment of the aforesaid process, the reaction temperature in steps (a), (b) and (c) is between 20° C. and 120° C.; reaction time in step (a) is 0.5˜4 hours; reaction time in step (b) is 2˜24 hours; and reaction time in step (c) is 0.5˜4 hours.

A further objective of the present invention is to provide a method for treating textile or leather, comprising applying the solvent-based fluorinated water and oil repellent of the present invention to the textile or leather to obtain textile or leather with water and oil repellency.

The method of applying solvent-based fluorinated water and oil repellent to textile or leather includes, but not limited to, padding, atomization, coating and spraying to obtain textile or leather with water and oil repellency.

Yet another objective of the present invention is to provide a textile or leather with water and oil repellency which is treated with the solvent-based fluorinated water and oil repellent of the present invention.

The solvent-based fluorinated water and oil repellent of the present invention exists in the form of solvent dispersant, which is free of highly toxic solvents commonly contained in the solvent-based water and oil repellent currently on the market, such as benzene, toluene and xylene, while retaining excellent water and oil repellency. The fluorinated water and oil repellent of the present invention also has washing durability and superior stability and physical properties. It may be applied extensively in textile, leather and paper industries by the simple means of spraying or coating. The water-oil repellent of the present invention also exhibits excellent penetration that enhances the effect of water and oil repellency, and at the same time, helps to lower the curing temperature and improve the condition of discoloration of treated product, hence increasing the commercial value of the product.

### DETAILED DESCRIPTION OF THE INVENTION

The present invention relates to a solvent-based fluorinated water and oil repellent comprising 20˜50% (w/w) blocked polyfluorourethane compound and 50˜80% (w/w) solvent; its reaction agents include fluoroalcohol compound, diisocyanate or polymeric diisocyanate compound, cross-linking agent, blocking agent and solvent.

The process for producing solvent-based fluorinated water and oil repellent of the present invention employs bulk polymerization to synthesize blocked polyfluorourethane, comprising the steps of first reacting cross-linking agent with diisocyanate or polymeric diisocyanate compound to form a prepolymer having 1˜3 mol equivalent percentage of —NCO groups; reacting said prepolymer with fluoroalcohol compound and retaining 0.5˜1.5 mol equivalent percentage of —NCO group; and finally blocking the unreacted —NCO group with blocking agent to obtain the solvent-based fluorinated water and oil repellent. The aforesaid process may employ batch polymerization or semi-continuous polymerization.

The fluoroalcohol compound used in the present invention includes perfluoroalkyl alcohol compound or perfluoropolyether alcohol compound. Said fluoroalcohol compound include, but not limited to, compounds having the following structures:

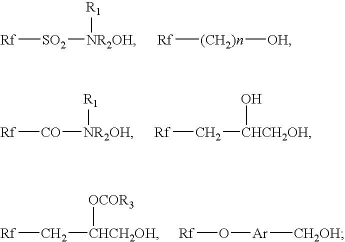

Wherein Rf is C₃₋₂₁ polyfluoroalkyl, polyfluoro alkyl or perfluoropolyether having average molecular weight of 400-5000, R₁ is hydrogen or C₁₋₁₀ alkyl, R₂ is C₁₋₁₀ alkylene, R₃ is hydrogen or methyl, Ar is substituted phenyl, and n is an integer from 1 to 10.

The aforesaid perfluoropolyether can have the formula of:

| | |
|---|---|
| F(CF(CF₃)CF₂O)ₙCF₂CF₂— | wherein n is an integer |
| | from 3 to 30. |
| CF₃O(CF(CF₃)CF₂O)ₙ(CF₂O)ₘCF₂— | wherein n is an integer |
| | from 2 to 30 and m is an |
| | integer from 3 to 70. |
| CF₃O(CF₂CF₂O)ₙ(CF₂O)ₘCF₂— | wherein n is an integer |
| | from 2 to 40 and m is an |
| | integer from 4 to 70. |
| F(CFCF₂CF₂O)ₙCF₂CF₂— | wherein n is an integer |
| | from 3 to 30. |

Examples of the fluoroalcohol compound include, but not limited to,
CF₃(CF₂)₇(CH₂)OH,
CF₃(CF₂)₆(CH₂)OH,
(CF₃)₂CF(CF₂)₆(CH₂)₂OH,
CF₃(CF₂)₇(CH₂)₂OH,
(CF₃)₂(CF₂)₆(CH₂)₂OH,
CF₃(CF₂)₇SO₂N(CH₃)(CH₂)₂OH.
(CF₃)₂CF(CF₂)₆CH₂CH(OCOCH₃)CH₂OH,
(CF₃)₂CF(CF₂)₆CH₂CH(OH)CH₂OH,
C₈F₁₇—O—Ar—CH₂OH,
C₆F₁₃—O—Ar—CH₂OH,
F(CF(CF₂)CF₂O)₁₀ CF₂ CF₂—OH,
or mixtures thereof.

The diisocyanate or polymeric diisocyanate compound used in the present invention comprises aromatic diisocyanate or polymers thereof, or aliphatic diisocyanate or polymers thereof.

Examples of the aromatic diisocyanate or polymers thereof include, but not limited to, toluene diisocyanate (TDI) or polymers thereof, methylene diphenyl diisocyanate (MDI) or polymers thereof, naphthylene diisocyanate (NDI) or polymers thereof, and the mixtures of aforesaid diisocyanate or diisocyanate polymers.

Examples of the aliphatic diisocyanate or polymers thereof include, but not limited to, hexamethylene diisocyanate (HDI), xylene diisocyanate (XDI), dicyclohexylmethane diisocyanate (H₁₂MDI), isophorone diisocyanate (IPDI), cyclobutane diisocyanate, transcyclohexane diisocyanate (CHDI), cyclohexane bis(methylene diisocyanate) (BDI), 1,3-bis (methylisocyanate) cyclohexane (H₆XDI), 3-isocyanato-3,5,5-trimethylcyclohexylisocyanate, 1,4-tetramethylene diisocyanate, hexamethylene, 1,4-diisocyanate, 1,12-dodecane diisocyanate, trimethylhexamethylene diisocyanate (TMDI), 2-methyl-1,5-pentamethylene diisocyanate, tetramethylxylene diisocyanate (TMXDI), mixtures of aforesaid diisocyanate, polymers of aforesaid diisocyanate polymers, and mixtures of aforesaid polymers.

The cross-linking agent used in the present invention comprises triol cross-linking agent. Examples of said cross-linking agent include, but not limited to, poly(oxypropylene)triol, polyoxypropylene polyoxyethylene triol, trimethylol propane, glycerol, hexane triol, or mixture thereof.

Examples of the blocking agent include, but not limited to, methanol, ethanol, ethylmercaptain, β-thionaphthol, N-methylaniline, acetoxime, cyclohexanone oxime, Butanone oxime, diethylmalonate, acetylacetone, acetoethylacetate, ε-caprolactam, 3,5-dimethylpyrazole, diisopropylamine, phenol, or mixtures thereof.

Examples of the solvent include, but not limited to, methanol, ethanol, isopropanol, ethyl acetate, butyl acetate, acetone, butanone, methyl isobutyl ketone, ethylene glycol, hexylene glycol, propylene glycol, dipropyleneglycol monobutylether, dipropylene glycol, butylcellosolve (butoxyethanol), and mixtures thereof.

The solvent-based fluorinated water and oil repellent according to the present invention imparts the treated textile fabric, leather goods and paper products with water and oil repellency. The treatment process may employ any of the known techniques. For example, the water and oil repellent provided herein may be applied to leather goods by spray coating, and the treated leather goods are then air dried or heat cured to obtain water and oil repellency. The time required for the aforesaid air drying or heat curing process varies, depending on a number of factors, such as the composition and weight of the substrate and the amount of residual solvent left thereon. The solvent-based water and oil repellent may also applied to textile surface singularly or in diluted form by means of padding, spraying or coating. If necessary, the step of heat curing can be added in the treatment process. For example, heat treating the textile between 100° C. and 190° C. for at least 60 seconds, typically 60 to 200 seconds to impart it with superior water and oil repellency as well as wash durability.

The following examples are used to further illustrate the preparation of the solvent-based fluorinated water and oil repellent of the present invention and applications thereof, but the descriptions made in the examples should not be construed as a limitation on the actual application of the present invention.

Preparation of Solvent-Based Fluorinated Water and Oil Repellent

### EXAMPLE 1

Place 24.75 g of trimethylol propane into a 2L glass reactor equipped with an agitating device, vacuum motor, a thermometer, and cooling device. First, vacuum the reactor and purge with nitrogen to replace air 30 minutes later. Then add 123.75 g of IPDI into the glass reactor and raise the temperature to 85˜90° C. After maintaining the reactor temperature for 2 hours, start measuring the percentage of NCO. When the percentage of NCO reaches 16-18%, add 231 g of CF₃(CF₂)₇(CH₂)₂OH and raise the temperature to 95° C. Let the reaction continue to 4 hours and start measuring the percentage of NCO. When the percentage of NCO reaches 1.5˜2.0%, add 325.5 g of butanone and maintain the reactor temperature under 70±3° C. for 10 hours. Subsequently drop the temperature to 50±3° C., then add 15 g of butanone oxime and let the reaction continue for 1 hour. Afterwards, add 600 g of butanone and 150 g of butyl acetate and mix for 30 minutes. Following polymerization reaction, the resulting polymer dispersant weighed 1470 g with solid content of 24.1%.

### EXAMPLE 2

Place 24.5 g of trimethylol propane into a 2L glass reactor equipped with an agitating device, vacuum motor, a thermometer, and cooling device. First, vacuum the reactor and purge the reactor with nitrogen for 30 minutes to replace air. Then add 29.5 g of HDI and 85 g of IPDI into the glass reactor and raise the temperature to 85˜90° C. After maintaining the reactor temperature for 2 hours, start measuring the percentage of NCO. When the percentage of NCO reaches 16-18%, add 231 g of CF₃(CF₂)₇(CH₂)₂OH and raise the temperature to 95° C. Let the reaction continue to 4 hours and start measuring the percentage of NCO. When the percentage of NCO reaches 1.5˜2.0%, add 320 g of butanone and maintain the reactor temperature under 70±3° C. for 10 hours. Subsequently, drop the temperature to 50±3° C., then add 15 g of butanone oxime and let the reaction continue for 1 hour. Afterwards, add 400 g of butanone and 350 g of ethyl acetate and mix for 30 minutes. Following polymerization reaction, the resulting polymer dispersant weighed 1455 g with solid content of 24.3%.

### EXAMPLE 3

The materials, weights and polymerization processes in this example are identical to those in Example 1, only the material used in the second-stage polymerization CF₃(CF₂)₇(CH₂)₂OH is replaced by the mixture of 105 g of CF₃(CF₂)₇(CH₂)₂OH and 112.5 g of CF₃(CF₂)₆(CH₂)₂OH. Following polymerization reaction, the resulting polymer dispersant weighed 1456.5 g with solid content of 24.1%.

### EXAMPLE 4

The materials, weights and polymerization methods in this example were identical to those in Example 2, only the material used in the second-stage polymerization CF₃(CF₂)₇(CH₂)₂OH was replaced by the mixture of 105 g of CF₃(CF₂)₇(CH₂)₂OH and 112.5 g of CF₃(CF₂)₆(CH₂)₂OH. Following polymerization reaction, the resulting polymer dispersant weighed 1441.5 g with solid content of 24.1%.

### EXAMPLE 5

The materials, weights and polymerization methods in this example were identical to those in Example 2, only the weight of CF₃(CF₂)₇(CH₂)₂OH used in the second-stage polymerization was changed to 220 g and that of butanone oxime used in the third-stage polymerization was changed to 17.5 g. Following polymerization reaction, the resulting polymer dispersant weighed 1446.5 g with solid content of 24.2%.

Applications of Solvent-Based Fluorinated Water and Oil Repellent

Testing Methods

(1) Treatment of Fabric

Dilute part of the solvent-based fluorinated water and oil repellent prepared with proper solvent to a treatment fluid containing 0.5-2% solid polymer by weight. Apply it to the selected fabrics, such as nylon tafeeta, polyester fiber or cotton fabric by dipping, and then heat the fabrics at 150° C. for 30 seconds.

1-1 Water Repellency Test

Use AATCC Standard Test Method No. 22 to test the water repellency of treated fabric specimen (see Table 1)

TABLE 1

| Water Repellency | |
|---|---|
| Rating Number | Condition |
| 100 | No wetting on surface |
| 90 | Slight wetting on surface |
| 80 | Partial wetting on surface |
| 70 | Wetting on surface |
| 50 | Wetting on entire surface |
| 0 | Complete Wetting on |
| | entire fabric inside out |

In the test, 250 ml of water is poured in a narrow stream at a 27 degree angle onto the fabric specimen stretched on a 6-inch diameter plastic loop. The water was discharged from a funnel suspended six inches above the fabric sample. After removal of excess water, the fabric was visually scored according to the published standards.

1-2 Oil Repellency Test

Use AATCC Standard Test Method No. 118 to test the oil repellency of treated fabric specimen (Table 2)

TABLE 2

| Oil repellency | |
|---|---|
| Rating Number | Test Liquid |
| 8 | n-Heptane |
| 7 | n-Octane |
| 6 | n-Decane |
| 5 | n-Dodecane |
| 4 | n-Tetradecane |
| 3 | n-Hexadecane |
| 2 | n-Hexadecane 35%/Nujol 65% |
| 1 | Nujol |
| 0 | Less than 1 |

In the test, a series of organic liquids described above are applied dropwise to the fabric samples. Beginning with the lowest numbered test liquid, one drop (about 5 mm in diameter or 0.05 mL volume) was placed on each three locations at least 5 mm apart. The drop was observed for 30 seconds. If, at the end of this period, two of the three drops were still in spherical to hemispherical shape with no wicking around the drops, three drops of the next highest numbered test liquid were placed on adjacent sites and similarly observed for 30 seconds. Continue the test until one of the test liquid results in two of the three drops failing to remain spherical or hemispherical shape or wetting occurs. The oil repellency rating of the fabric is the highest numbered test liquid for which two of the three drops remain spherical to hemispherical, with no wicking for 30 seconds.

1-3 Discoloration Test

X-Rite 948 is used to measure the total color difference (ΔE) of fabric specimen before and after the treatment of water and oil repellent.

(2) Treatment of Leather

Dilute part of the solvent-based fluorinated water and oil repellent prepared with proper solvent to a treatment fluid containing 5% solid polymer by weight. Apply it to the selected leather, such as split leather and pig skin leather using a spray gun. Preheat the treated leather in 80° C. oven for 3 minutes and then place it under 25° C. environment for 24 hours.

2-1 Oil Resistance Test

Apply standard test oil dropwise to the leather surface and observe the surface wetting of the leather. The oil resistance rating of leather is the highest numbered test oil that does not produce wicking on leather surface. Beginning with the lowest grade test oil, carefully place one drop of test oil on each of three different locations of leather surface and observe for 30 seconds. If, at the end of this period, no wicking around the drops occurs, observe the next highest grade test oil by the same step. Continue the test until apparent wicking of the leather surface is observed. The oil repellency rating of the fabric is the highest grade test oil that does not produce wicking on leather surface in 30 seconds (see Table 3).

TABLE 3

| Oil repellency Rating | Test Liquid |
|---|---|
| 1 | Mineral oil with viscosity of |
| | 140 dynes/cm |
| 2 | 65:35 mineral oil:n-hexadecane |
| 3 | n-Hexadecane |
| 4 | n-Tetradecane |
| 5 | n-Dodecane |

2-2 Water Resistance Test

Apply standard test liquid dropwise to the leather surface and observe the surface wetting of the leather. The water resistance rating of leather is the highest numbered standard test liquid that does not produce wicking on leather surface. Beginning with the lowest grade test liquid, carefully place one drop of test liquid on each of three different locations of leather surface and observe for 10 seconds. If, at the end of this period, no wicking around the drops occurs, observe the next highest grade test liquid by the same step. Continue the test until apparent wicking of the leather surface is observed. The water repellency rating of the leather is the highest grade test liquid that does not produce wicking on leather surface in 10 seconds (see Table 4).

TABLE 4

| | Test liquid: |
|---|---|
| Water Repellency Rating | water/isopropanol |
| 1 | 98/2 |
| 2 | 95/5 |
| 3 | 90/10 |
| 4 | 80/20 |
| 5 | 70/30 |

### EXPERIMENT EXAMPLE 1

The solvent-based fluorinated water and oil repellent prepared in Examples 1 above was diluted with butanone into treatment fluid having solid content of 0.5 wt %. The polyester fabric was immersed in said treatment fluid, squeezed by roller to 60% pick-up, and then dried at 120° C. for 2 minutes. The resulting polyester fabric specimen obtained was evaluated for water repellency and oil repellency. The results are depicted in Table 5 below.

### EXPERIMENT EXAMPLE 2-5

The solvent-based fluorinated water and oil repellents prepared in Examples 2-5 above were diluted with butanone into treatment fluid having solid content of 0.5 wt %. The polyester fabric was immersed in said treatment fluid, squeezed by roller to 60% pick-up, and then dried at 120° C. for 2 minutes. The resulting polyester fabric specimen obtained was evaluated for water repellency and oil repellency. The results are depicted in Table 5 below.

### COMPARATIVE EXAMPLE 1

Fluorinated water and oil repellent A bought on the market was diluted with water into treatment fluid having solid content of 0.5 wt %. The polyester fabric was immersed in said treatment fluid, squeezed by roller to 60% pick-up, and then dried at 120° C. for 2 minutes. The resulting polyester fabric specimen obtained was evaluated for water repellency and oil repellency. The results are depicted in Table 5 below.

TABLE 5
(Fabric)

| | Water | Oil | Dis- |
|---|---|---|---|
| | repellency | repellency | coloration |
| | (Rating No.) | (Rating No.) | (ΔE) |
| Experiment Example 1 | 100 | 5 | 0.41 |
| Experiment Example 2 | 100 | 6 | 0.42 |
| Experiment Example 3 | 100 | 6 | 0.37 |
| Experiment Example 4 | 100 | 6 | 0.29 |
| Experiment Example 5 | 100 | 5 | 0.47 |
| Comparative Example 1 | 90 | 3 | 0.96 |

As shown in Table 5, the solvent-based fluorinated oil and water repellent of the present invention, in comparison with water and oil repellents currently available on the market, displays better water and oil repellency when applied to textile fabrics and produces optimum effect on the discoloration of the textile.

### EXPERIMENT EXAMPLE 6

The solvent-based fluorinated water and oil repellent prepared in Examples 1 above was diluted with ethyl acetate into treatment fluid having solid content of 5 wt %. Split leather product was sprayed with said treatment fluid using a spray gun. The treated leather was pre-dried in 80° C. oven for 3 minutes and then placed in 25° C. environment for 24 hours. The resulting leather specimen obtained was evaluated for water repellency and oil repellency. The results are depicted in Table 6 below.

### EXPERIMENT EXAMPLE 7-10

The solvent-based fluorinated water and oil repellent prepared in Examples 2-5 above was diluted with ethyl acetate respectively into treatment fluid having solid content of 5 wt %. The split leather was sprayed with said treatment fluid by a spray gun. The treated leather was pre-dried in 80° C. oven for 3 minutes and then placed in 25° C. environment for 24 hours. The resulting leather specimen obtained was evaluated for water repellency and oil repellency. The results are depicted in Table 6 below.

### COMPARATIVE EXAMPLE 2

Fluorinated water and oil repellent B bought on the market was diluted with toluene into treatment fluid having solid content of 5 wt %. Split leather product was sprayed with said treatment fluid using a spray gun. The treated leather was pre-dried in 80° C. oven for 3 minutes and then placed in 25° C. environment for 24 hours. The resulting leather specimen obtained was evaluated for water repellency and oil repellency. The results are depicted in Table 6 below.

TABLE 6
(Leather)

| | Water repellency | Oil repellency |
|---|---|---|
| | (Rating No.) | (Rating No.) |
| Experiment Example 6 | 6 | 5 |
| Experiment Example 7 | 6 | 5 |
| Experiment Example 8 | 6 | 5 |
| Experiment Example 9 | 6 | 5 |
| Experiment Example 10 | 6 | 4 |
| Comparative Example 2 | 5 | 2 |

As shown in Table 6, the solvent-based fluorinated oil and water repellent of the present invention, in comparison with water and oil repellents currently available on the market, exhibits better water and oil repellency when applied to leather goods.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

The preferred embodiments of the present invention have been disclosed in the examples. However the examples should not be construed as a limitation on the actual applicable scope of the invention, and as such, all modifications and alterations without departing from the spirits of the invention and appended claims, including the other embodiments shall remain within the protected scope and claims of the invention.

1. A solvent-based fluorinated water and oil repellent, comprising 20-50% (w/w) blocked polyfluorourethane compund and 50-80% (w/w) solvent.

2. The solvent-based fluorinated water and oil repellent according to claim 1, wherein said solvent comprises methanol, ethanol, isopropanol, ethyl acetate, butyl acetate, acetone, butanone, methyl isobutyl ketone, ethylene glycol, hexylene glycol, propylene glycol, dipropyleneglycol monobutylether, dipropylene gylcol, butylcellosolve, or mixtures thereof.

3. The solvent-based fluorinated water and oil repellent according to claim 1, wherein the reaction agents of said blocked polyfluorourethane comprise:
fluoroalcohol compound;
diisocynate or polymeric isocyanate compound;
cross-linking agent;
blocking agent; and
solvent.

4. The solvent-based fluorinated water and oil repellent according to claim 3, wherein said fluoroalcohol compound comprises perfluoroalkyl alcohol compound or perfluoropolyether alcohol compound.

5. The solvent-based fluorinated water and oil repellent according to claim 3, wherein said fluoroalcohol compound comprises comopunds having the following structures: 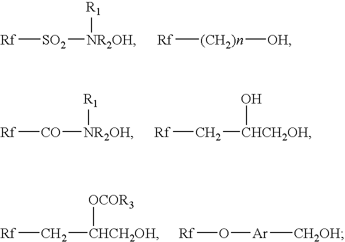
wherein Rf is C₃₋₂₁ polyfluoroalkyl, polyfluoro alkyl or perfluoropolyether having average molecular weight of 400-5000, R₁ is hydrogen or C₁₋₁₀ alkyl, R₂ is C₁₋₁₀ alkylene, R₃ is hydrogen or methyl, Ar is substituted phenyl, and n is an integer from 1 to 10.

6. The solvent-based fluorinated water and oil repellent according to claim 5, wherein the formula of said perfluoropolyether comprises:

| | |
|---|---|
| F(CF(CF₃)CF₂O)ₙCF₂CF₂— | wherein n is an integer |
| | from 3 to 30. |
| CF₃O(CF(CF₃)CF₂O)ₙ(CF₂O)ₘCF₂— | wherein n is an integer |
| | from 2 to 30 and m is |
| | an integer from 3 to 70. |
| CF₃O(CF₂CF₂O)ₙ(CF₂O)ₘCF₂— | wherein n is an integer |
| | from 2 to 40 and m is |
| | an integer from 4 to 70. |
| F(CFCF₂CF₂O)ₙCF₂CF₂— | wherein n is an integer |
| | from 3 to 30. |

7. The solvent-based fluorinated water and oil repellent according to claim 4, wherein said fluoroalcohol compound comprises:
CF₃(CF₂)₇(CH₂)OH;
CF₃(CF₂)₆(CH₂)OH;
(CF₃)₂CF(CF₂)₆(CH₂)₂OH;
CF₃(CF₂)₇(CH₂)₂OH;
(CF₃)₂(CF₂)₆(CH₂)₂OH;
CF₃(CF₂)₇SO₂N(CH₃)(CH₂)₂OH;
(CF₃)₂CF(CF₂)₆CH₂CH(OCOCH₃)CH₂OH;
(CF₃)₂CF(CF₂)₆CH₂CH(OH)CH₂OH;
C₈F₁₇—O—Ar—CH₂OH;
C₆F₁₃—O—Ar—CH₂OH;
F(CF(CF₂)CF₂O)₁₀ CF₂ CF₂—OH;
or mixtures thereof.

8. The solvent-based fluorinated water and oil repellent according to claim 3, wherein said diisocyanate or polymeric diisocyanate compound comprises aromatic diisocyanate or polymers thereof, or aliphatic diisocyanate or polymers thereof.

9. The solvent-based fluorinated water and oil repellent according to claim 8, wherein said aromatic diisocyanate or polymers thereof comprise: toluene diisocyanate (TDI) or polymers thereof, methylene diphenyl diisocyanate (MDI) or polymers thereof, naphthylene diisocyanate (NDI), or polymers thereof, mixtures of said diisocyanate or mixtures of said diisocyanate polymers.

10. The solvent-based fluorinated water and oil repellent according to claim 8, wherein said aliphatic diisocyanate or polymers thereof comprise: hexamethylene diisocyanate (HDI), xylene diisocyanate (XDI), dicyclohexylmethane diisocyanate (H₁₂MDI), isophorone diisocyanate (IPDI), cyclobutane diisocyanate, trans-cyclohexane diisocyanate (CHDI), cyclohexane bis(methylene diisocyanate) (BDI), 1,3-bis (methylisocyanate) cyclohexane (H₆XDI), 3-isocyanato-3,5,5-trimethylcyclohexylisocyanate, 1,4-tetramethylene diisocyanate, hexamethylene 1,4-diisocyanate, 1,12-dodecane diisocyanate, trimethylhexamethylene diisocyanate (TMDI), 2-methyl-1,5-pentamethylene diisocyanate, tetramethylxylene diisocyanate (TMXDI), mixtures of said diisocyanate, polymers of said diisocyanate, or mixtures of said diisocyanate polymers.

11. The solvent-based fluorinated water and oil repellent according to claim 3, wherein said cross-linking agent is a triol cross-linking agent.

12. The solvent-based fluorinated water and oil repellent according to claim 11, wherein said triol cross-linking agent comprises poly(oxypropylene)triol, polyoxypropylene polyoxyethylene triol, trimethylol propane, glycerol, hexane triol, or mixtures thereof.

13. The solvent-based fluorinated water and oil repellent according to claim 3, wherein said blocking agent comprises: methanol, ethanol, ethylmercaptain, β-thionaphthol, N-methylaniline, acetoxime, Cyclohexanone oxime, Butanone oxime, diethylmalonate, acetylacetone, acetoethylacetate, ε-caprolactam, 3,5-dimethylpyrazole, diisopropylamine, phenol, or mixtures thereof.

14. The solvent-based fluorinated water and oil repellent according to claim 13, wherein said solvent comprises methanol, ethanol, isopropanol, ethyl acetate, butyl acetate, acetone, butanone, methyl isobutyl ketone, ethylene glycol, hexylene glycol, propylene glycol, dipropyleneglycol monobutylether, dipropylene gylcol, butylcellosolve, or mixture thereof.

15. A process for producing solvent-based fluorinated water and oil repellent, comprising the steps of:
(a) reacting cross-linking agent with diisocyanate or polymeric isocyanate compound to form a prepolymer having 1˜3 mol equivalent percentage of terminal —NCO group;
(b) reacting said prepolymer with fluoroalcohol to form polyfluorourethane polymer having 0.5˜1.5 mol equivalent percentage of unreacted terminal —NCO groups; and
(c) blocking said —NCO groups with blocking agent to obtain blocked polyfluorourethane.

16. The process according to claim 15, wherein said process is batch polymerization reaction or semi-continuous polymerization reaction.

17. The process according to claim 15, wherein in step (a), 0.4˜0.6 mol equivalent percentage of cross-linking agent reacts with 0.8˜1.2 mol equivalent percentage of diisocyanate or polymeric isocyanate to form a prepolymer.

18. The process according to claim 15, wherein in step (b), prepolymer obtained in step (a) reacts with 0.3˜0.6 mol equivalent percentage of fluoroalcohol compound to form polyfluorourethane polymer.

19. The process according to claim 15, wherein in step (c), 0.05˜0.4 mol equivalent percentage of blocking agent is used to block unreacted —NCO groups in step (b) to obtain blocked polyfluorourethane.

20. A process for producing solvent-based fluorinated water and oil repellent, comprising the steps of:
(a) reacting 0.4˜0.6 mol equivalent percentage of cross-linking agent with 0.8˜1.2 mol equivalent percentage of diisocyanate or polymeric diisocyanate compound to form a prepolymer having 1˜3 mol equivalent percentage of terminal —NCO groups;
(b) reacting said prepolymer with 0.3˜0.6 mol equivalent percentage of fluoroalcohol to form polyfluorourethane having 0.5˜1.5 mol equivalent percentage of unreacted terminal —NCO groups; and
(c) blocking said —NCO groups with 0.05˜0.4 mol equivalent percentage of blocking agent to obtain blocked polyfluorourethane.

21. The process according to claim 20, wherein said process further comprises the step of adding 50˜80 mol equivalent percentage of solvent in each step.

22. The process according to claim 20, wherein the reaction temperature in steps (a), (b), and (c) range between 20° C. and 120° C.

23. The process according to claim 20, wherein the reaction time in step (a) is 0.5˜4 hours.

24. The process according to claim 20, wherein the reaction time in step (b) is 2˜24 hours.

25. The process according to claim 20, herein the reaction time in step (c) is 0.5˜4 hours.

26. A method for treating textile or leather, comprising the step of applying solvent-based fluorinated water and oil repellents of claim 1 to textile or leather to obtain textile or leather with water and oil repellency.

27. The method according to claim 26, wherein said method comprises applying said solvent-based fluorinated water and oil repellent on textile or leather by means of padding, atomization, coating or spraying to obtain textile or leather with water and oil repellency.

28. A textile or leather with water and oil repellent which is treated with the solvent-based fluorinated water and oil repellents of claim 1.
